(19) United States
(12) Patent Application Publication
(10) Pub. No.: US 2002/0072964 A1
(43) Pub. Date: Jun. 13, 2002

(54) Apparatus and method for settling parking charge using DSRC

(75) Inventor: Kwang-Joo Choi, Dongan-Ku (KR)

Correspondence Address: FLESHNER & KIM, LLP, P.O. Box 221200, Chantilly, VA, 20153-1200, US

(73) Assignee: LG Electronics Inc.

(21) Appl. No.: 09/983,746

(22) Filed: Oct. 25, 2001

(30) Foreign Application Priority Data
Dec. 7, 2000 (KR) 74181/2000

(51) Int. Cl. G06F 17/60

(52) U.S. Cl. 705/13

(57) ABSTRACT

A parking charge settling apparatus includes an Electronic Toll Collection (ETC) terminal that stores registration information for parking charge settlement, analyzes the stored information, and transmits the registration information in a dedicated short range communication (DSRC) format; a vehicle sensor managing server that communicates with a vehicle sensor installed at a parking space to manage parking state information; a DRSC base station that communicates bi-directionally with the ETC terminal using the DSRC format, when a vehicle mounting the ETC terminal enters a predetermined range; a settlement center server that informs the vehicle entering the parking lot of an available parking space, computes a parking charge, and settles the parking charge with the ETC terminal; a first displayer that displays available parking space information received from the settlement center server; and a second displayer that displays the parking charge and whether the vehicle is allowed to pass.

### BACKGROUND OF THE INVENTION

1. Field of the Invention

The present invention relates to an automatic parking charge settlement system and, more particularly, to an apparatus and method for settling a parking charge using a Dedicated Short Range Communication (DSRC).

2. Background of the Related Art

Generally, a parking management system includes a vending machine installed at an entrance of a parking lot, for issuing a parking receipt, and a server for driving the vending machine to issue the parking receipt when a vehicle enters the vehicle shed. The server also reads information recorded on the parking receipt when the vehicle is taken out. When the vehicle enters the parking lot, the vending machine issues a parking receipt to the driver. When the vehicle drives out of the parking lot, the management window receives the parking receipt and reads it by means of the server, to compute a parking charge.

However, the related art technique has the following shortcomings. A parking lot operator is needed at every exit of the lot. If the lot has several exits, then several operators are needed, thereby increasing the operating expenses of the lot. Also, the driver consumes time looking for a space where he or she can park the vehicle. In addition, the vehicle consumes energy while the driver stops to receive a parking receipt or pay a parking charge, thereby increasing the operational and maintenance expenses for the vehicle.

Accordingly, there has been proposed several parking charge settling methods which interwork with various communication methods. One of them is a Frequency Modulation-Data Radio Channel (FM-DARC) radio communication method in which digital data is transmitted by using an existing FM (Frequency Modulation) broadcast channel. With this method, the transfer rate is 16 kbps at the maximum and the communication cell size is as wide as scores of the transfer rate. The method employs a wide band service and an existing broadcast channel, so the digital transmitter and receiver can be easily implemented.

Another method employs a beacon radio communication method in which a bidirectional communication is available between a vehicle terminal and a road side base station. When used for a parking service, it provides users' convenience in that the parking charge is automatically settled and an available parking space is assigned.

Still another parking charge settling method works with a cellular radio communication method in which a circuit communication method is employed to provide a voice service even when the driver is driving.

Yet another is a parking charge settling method interworking with an International Mobile Telecommunication-2000 (IMT-2000). This method is being developed to provide a packet data service as well as a voice service.

However, the above-described related art techniques have the following problems. Firstly, in case of the technique using the FM-DARC radio communication method, since it uses the broadcast channel, only a one-directional service is available. This one-directional service provides only a downward link. Secondly, in the case of the beacon radio communication method, multiple connections with several vehicle terminals are not supported. Only one vehicle terminal may access the base station of a cell at a time. Thirdly, in the case of the cellular radio communication method, the user should keep continuously linked with the cellular base station to receive information. Maintaining a continuous circuit link increases the service fee. Lastly, in the case of the IMT-2000 radio communication method, the frequency bandwidths differ depending on the provided service. Therefore, the user should vary a communication frequency according to his or her desired service.

### SUMMARY OF THE INVENTION

An object of the invention is to solve at least the above problems and/or disadvantages and to provide at least the advantages described hereinafter.

Therefore, an object of the present invention is to provide a parking charge settling apparatus and method using a DSRC in which registration information for a parking charge settlement is transmitted in a DSRC type communication from an Electronic Toll Collection (ETC) terminal, mounted in a vehicle entering into a parking lot. The communication is recognized and an ETC response informs the entering vehicle of a parking space. Registration information for a parking charge settlement is transmitted in a DSRC type communication from the ETC terminal mounted in a vehicle driving out from the parking lot. The registration information is recognized to automatically settle a parking charge and the parking charge is collected from the ETC terminal of the vehicle through a DSRC communication.

Another object of the present invention is to provide a parking charge settling apparatus and method using a DSRC which is capable of recognizing a parked vehicle to judge whether it is an illegal or a stolen vehicle. If the parked vehicle is an illegal or a stolen vehicle, it is reported to the police office or a control office.

Still another object of the present invention is to provide a parking charge settling apparatus and method using a DSRC which is capable of blocking a vehicle in case the vehicle is an illegal or a stolen one.

To achieve these and other advantages and in accordance with the purpose of the present invention, as embodied and broadly described herein, there is provided a parking charge settling apparatus using a DSRC including: an ETC terminal for storing registration information for parking charge settlement, analyzing the stored information and transmitting the registration information in a DSRC type; a vehicle sensor managing server for sensing a vehicle sensor installed at a parking space to manage parking state information; a DRSC base station for performing a bidirectional DSRC communication with the ETC terminal when a vehicle mounting the ETC terminal enters a predetermined range; a settlement center server for informing the vehicle entering the parking lot of an available parking space, computing a parking charge and settling the parking charge with the ETC terminal mounted in the vehicle driving out of the parking lot; a first displayer for displaying available parking space information received from the settlement center server when the vehicle is entering; and a second displayer for displaying the parking charge to be paid and whether the vehicle is allowed to pass when leaving the parking lot.

In order to achieve the above objects, there is also provided a parking charge settling method using a DSRC including the steps: monitoring whether there is a response from an ETC terminal while transmitting ETC broadcast information by a DSRC base station; transmitting response information from the ETC terminal to the DSRC base station as the ETC terminal enters a predetermined range and receives the ETC broadcast information; judging whether it is a vehicle leaving situation or a vehicle entering situation in case there is a response from the ETC terminal; authenticating a vehicle on the basis of a user identifier transmitted from the ETC terminal and assigning an available parking space, in case it is a vehicle entering situation; recognizing the user identifier transmitted from the ETC, computing a parking charge according to the parking time and transmitting the computed parking charge information to the ETC terminal, in case it is a vehicle leaving situation; and receiving the parking charge information, subtracting the parking charge from the balance of a smart card, and transmitting settlement completion information to the DSRC base station by the ETC terminal.

The objects of the present invention can be achieved in whole or in part by a subscriber fee settling system, including a subscriber terminal containing subscriber information; a base station that communicates with the subscriber terminal using a wireless medium; a server that communicates with the base station to receive the subscriber information communicated by the subscriber terminal to the base station, computes a subscriber fee based on the subscriber information, and communicates the subscriber fee to the subscriber terminal via the base station; and a service sensor that communicates with the server to identify whether a service is available for provisioning to a subscriber.

The objects of the present invention can be further achieved in whole or in part by a subscriber fee settling method, including communicating a service request from a subscriber terminal to a base station terminal by wireless communication; displaying the availability of a service for viewing by a subscriber having the subscriber terminal; and communicating a service fee from a server to the subscriber terminal, by wireless communication, and debiting the service fee from an account balance maintained by the subscriber terminal.

The foregoing and other objects, features, aspects and advantages of the present invention will become more apparent from the following detailed description of the present invention when taken in conjunction with the accompanying drawings.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a schematic block diagram of a parking charge settling apparatus using a DSRC in accordance with a preferred embodiment of the present invention;

FIG. 2 illustrates a network construction of the parking charge settling apparatus using a DSRC in accordance with a preferred embodiment of the present invention; and

FIGS. 3A and 3B illustrates a flow chart of a parking charge settling method using a DSRC in accordance with a preferred embodiment of the present invention.

### DETAILED DESCRIPTION OF PREFERRED EMBODIMENTS

Reference will now be made in detail to the preferred embodiments of the present invention, examples of which are illustrated in the accompanying drawings.

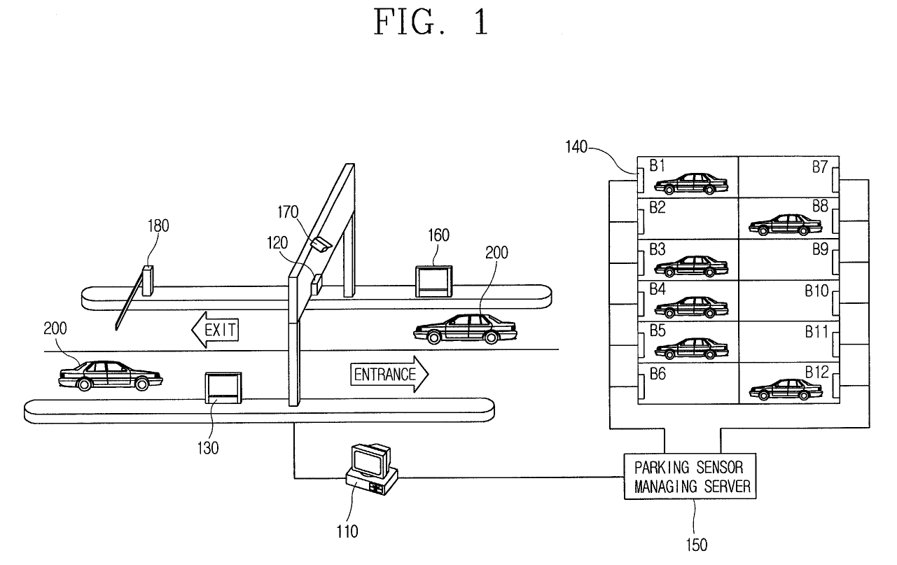

FIG. 1 is a schematic block diagram of a parking charge settling apparatus using a DSRC. The parking charge settling apparatus includes an ETC terminal 200 having a smart card that records and analyzes a user identifier and balance information and transmits the analyzed information to an external source by using its own power transmission function; a DSRC base station 120 for performing a bidirectional communication as a radio communication with the ETC terminal 200; a guide displayer 130 for providing a service to a driver of a vehicle entering a parking lot; a guide displayer 160 for informing the vehicle driver leaving the parking lot of a parking charge to be paid and whether he or she can pass; a monitoring camera 170 for photographing a vehicle and its driver in case the vehicle is an illegal or a stolen one; a lifting gate 180 for blocking the vehicle from leaving; a plurality of parking sensors 140 for sensing a parking state of vehicles parked at the parking lot; a parking sensor managing server 150 for checking the plurality of parking sensors 140 to identify the parking state and the available parking spaces; and a settlement center server 110 for communicating with the DSRC base station 120 and the parking sensor managing server 150 and displaying an available parking space on a screen of the guide displayer 130 when receiving the user identifier and balance information as the vehicle is entering, displaying on the screen of the guide displayer 160 the settled parking charge and whether the driver can pass, operating the monitoring camera 170 to photograph a vehicle and a driver in case the vehicle is judged to be an illegal or a stolen one, and operating the lifting gate 180 when the vehicle in question leaves the parking lot.

The ETC terminal 200 includes a smart card in which a user identifier (ID) and balance information are recorded. The ETC terminal 200 analyzes the information and transmits it to the DSRC base station 120 according to its own power transmission function. The ETC terminal 200 includes a smart card to automatically pay a parking charge through a radio communication with the DSRC base station 120.

The DSRC base station 120 is able to transmit and receive data to and from the ETC terminal 200 at a speed of 1 Mbps (Mega Bit Per Second). Additionally, the DSRC base station 120 may communicate with several ETC terminals at the same time with a single frequency, by using a Time Division Multiple Access (TDMA) method to heighten a channel utilization effect. Also, it may perform a DSRC communication by using an Industrial, Scientific and Medical (ISM) band frequency and a low-power radio frequency.

The communication between the settlement center server 110 and the DSRC base station 120 may selectively use a wired and a wireless method.

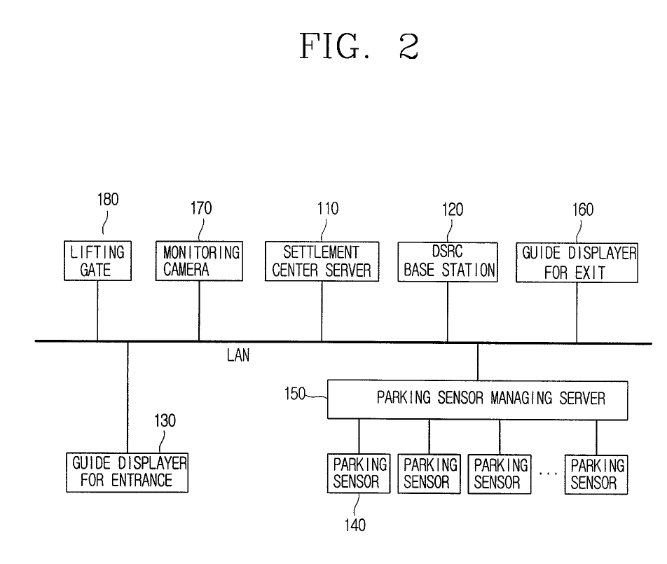

FIG. 2 illustrates a network construction of the parking charge settling apparatus using a DSRC. The settlement center server 110, the DSRC base station 120, the guide displayers 130 and 160, the parking sensor managing server 150, the monitoring camera 170, and the lifting gate 180 are connected by a Local Area Network (LAN).

The LAN may use an ethernet switch as necessary. The DSRC base station 120 simultaneously communicates with eight ETC terminals 200 by a single frequency, using the TDMA method. The plurality of parking sensors 140 and the parking sensor managing server 150 are connected by wire.

The ETC terminal 200 is mounted in a space available at the front of the driver's seat. Alternatively, it may be mounted in a control board inside the vehicle.

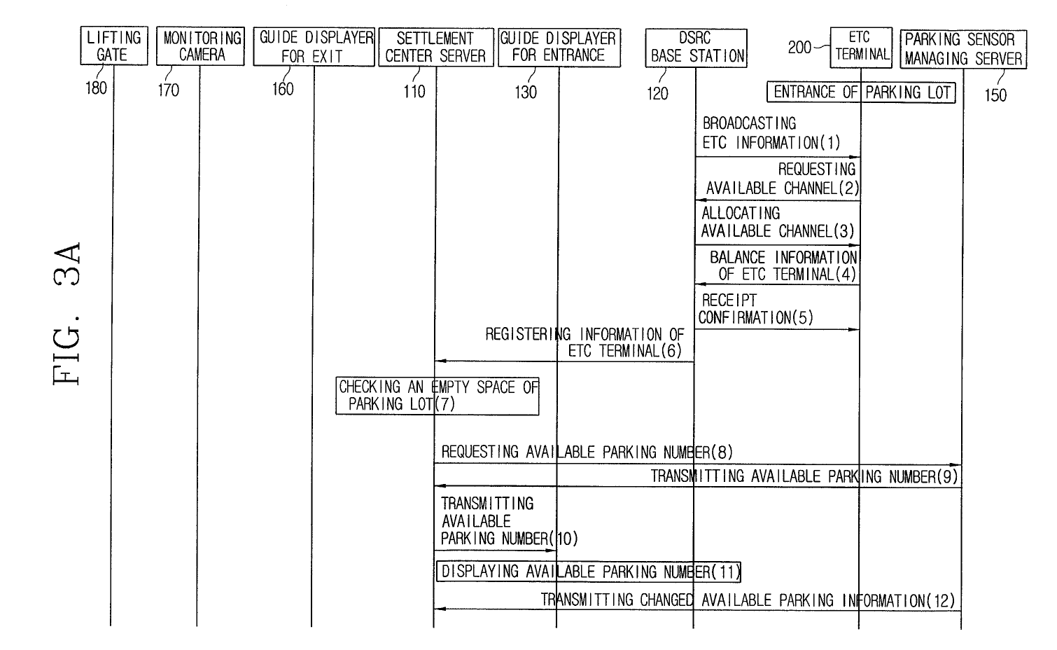

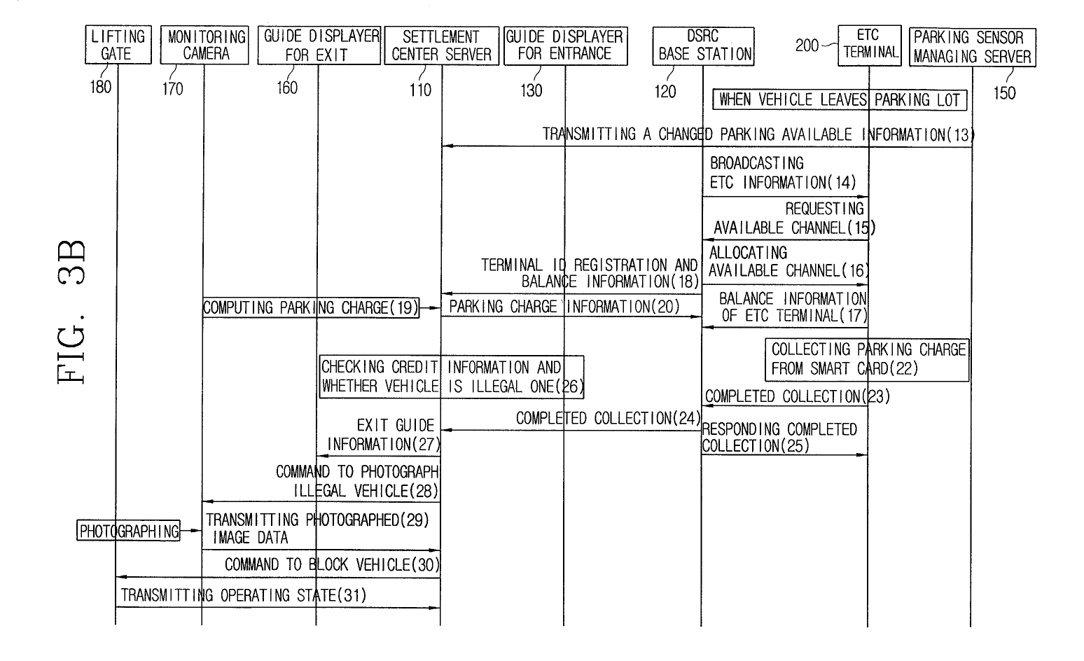

FIGS. 3A and 3B are a flow chart of a parking charge settling method using a DSRC. The operation and effect of the parking charge settling method will now be explained with reference to these Figures.

1) The operation when a vehicle enters the parking lot

When a vehicle carrying the ETC terminal 200 enters the parking lot, the ETC terminal 200 receives ETC broadcast information transmitted from the DSRC base station 120. The ETC terminal 200 analyzes the information and requests an available channel from the DSRC base station 120. Upon receipt of the available channel request, the DSRC base station 120 transmits available channel information to the ETC terminal 200.

Then, the ETC terminal 200 transmits registration information (i.e., user identifier (ID) and smart card balance information, etc) recorded in the smart card contained by the ETC terminal 200, to the base station 120. Upon receipt of the registration information, the DSRC base station 120 transmits it to the settlement center server 110 to validate the registration information of the ETC terminal 200. The settlement center server 110 performs an authentication process for the ETC terminal 200. If the ETC terminal is successfully authenticated, the settlement center server 110 communicates with the parking sensor managing server 150 to identify an available parking space.

In other words, the settlement center server 110 requests transmission of an available parking lot number from the parking sensor managing server 150. Then, the parking sensor managing server 150 transmits information regarding an available parking lot number to the settlement center server 110. Also, the settlement center server 110 transmits information regarding the available parking lot number to the guide displayer 130, so that an available parking space can be displayed on the screen of the guide displayer 130. Accordingly, the driver who has obtained the parking guide information at the entrance of the parking lot drives his or her vehicle to the available parking space for parking.

For example, with reference to FIG. 1, suppose vehicles have been parked in spaces B1, B3, B4, B5, B8 and B12. Any one available space among the remaining parking spaces is assigned and displayed on the guide displayer 130. Alternatively, all of the available parking spaces may be displayed on the screen of the guide displayer 130, so that the driver may select a desired space from a group of open parking spaces.

When the entering vehicle is parked, the parking sensor 140 senses the vehicle's presence in the selected space and transmits the sensed information to the parking sensor managing server 150.

Upon receipt of the information, the parking sensor managing server 150 transmits the parking information to the settlement center server 110, so that the settlement center server 110 can update its parking the information.

In the above descriptions, the parking sensor 140 senses only the parking state. But, it can be constructed to wirelessly communicate with the ETC terminal 200, so as to accurately judge whether a parked vehicle is an illegal or a stolen one. In addition, a monitoring camera may be provided to protect against stealing or another crime.

2) The operation when a vehicle leaves the parking lot

When a vehicle is leaving the parking lot, the parking sensor 140 transmits information informing the sensor managing server 150 that the space previously used by the vehicle has become empty. Then, the parking sensor managing server 150 transmits this information update to the settlement center server 110, so that the settlement center server 110 can update the database on the parking state.

When the vehicle drives out the exit of the parking lot, the ETC terminal 200 receives and analyzes the ETC broadcast information transmitted from the DSRC base station 120 and requests a transmission of available channel information from the DSRC base station 120. Then, the DSRC base station 120 transmits information regarding an empty channel, on a wireless channel, to the ETC terminal 200. The ETC terminal 200 transmits balance information of the smart card to the DSRC base station 120, using the channel information received from the DSRC base station 120. Then, the DSRC base station 120 transmits the registration information of the ETC terminal 200 and the balance information of the smart card to the settlement center server 110.

Accordingly, the settlement center server 110 checks the parking time of the vehicle exiting the parking lot, computes a parking charge, and transmits the parking charge to the DSRC base station 120. The DSRC base station 120 transmits the parking charge information to the ETC terminal 200, so that the parking charge is subtracted from the smart card. Once the ETC terminal 200 subtracts the parking charge from the smart card, it transmits settlement completion information to the DSRC base station 120, which is then transmitted to the settlement center server 110. In response the settlement center server 110 confirms its receipt of the settlement completion information by a communication with the ETC terminal 200, through the DSRC base station 120.

Meanwhile, the settlement center server 110 compares the registration information of the ETC terminal 200 with registration information of a server connected with a computer network of a police office or a banking institution, to identify credit information and check whether the vehicle is an illegal or stolen one.

The above described operations may be performed when the vehicle is entering the parking lot or driving out of the parking lot.

In case the vehicle is judged to be an abnormal one, the settlement center server 110 transmits guide information to the guide displayer 160, so as to be displayed on the screen. Also, the settlement center server 110 drives the monitoring camera 170 to photograph the illegal or stolen vehicle and its driver. After the monitoring camera 170 photographs the vehicle and its driver, it converts the photographed image to a data file and transmits it to the settlement center server 110. In addition, the settlement center server 110 transmits a command to the lifting gate 180 instructing it to block the vehicle. In response, the lifting gate 180 transmits its operating state information to the settlement center server 110.

If a Vehicle Navigation System (VNS), instead of the ETC terminal 200, is mounted in the vehicle, the VNS receives the same guide information displayed by the guide displayers 130 and 160. The VNS displays this information for the driver after receiving it from the DSRC base station 120 and displays it on its own Liquid Crystal Display (LCD). Accordingly, the driver can view the guide information displayed on the LCD of the VNS terminal, so that parking service information can be more conveniently provided to the driver.

As so far described, the parking charge settling apparatus and method using a DSRC has the following effects. Firstly, a small number of persons are needed to do a general management in the parking lot, so that the management expenses can be reduced. Secondly, an available parking space can be checked and a parking charge is settled for the driver's convenience without stopping his or her vehicle. Thirdly, the vehicle information is read and compared with information stored in the server, so that a credit status of a driver can be recognized. Also, the system may determine if the vehicle is identified as an illegal or a stolen one, so that a crime prevention effect can be obtained.

Consequently, the parking charge settling apparatus and method may be favorably adapted to a parking charge collecting system required for an underground parking lot or a large parking lot of department stores or large-scale buildings, so that drivers can conveniently use the parking lot and the parking service can be effectively managed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A parking charge settling apparatus, comprising:
an Electronic Toll Collection (ETC) terminal that stores registration information for parking charge settlement, analyzes the stored registration information, and transmits the registration information in a dedicated short range communication (DSRC) format;
a vehicle sensor managing server that communicates with a vehicle sensor installed at a parking space to manage parking state information;
a DRSC base station that communicates bi-directionally with the ETC terminal using the DSRC format, when a vehicle mounting the ETC terminal enters a predetermined range;
a settlement center server that informs the vehicle entering a parking lot of an available parking space, computes a parking charge, and settles the parking charge with the ETC terminal;
a first displayer that displays available parking space information received from the settlement center server; and
a second displayer that displays the parking charge and whether the vehicle is allowed to pass.

2. The apparatus of claim 1, wherein the ETC terminal includes a smart card that records the registration information, including a user identifier and a balance, and automatically subtracts the parking charge computed by the settlement center server from the balance of the smart card.

3. The apparatus of claim 1, further comprising a monitoring camera that monitors and photographs a state of vehicles in the parking lot.

4. The apparatus of claim 1, further comprising a lifting gate that blocks the vehicle from leaving the parking lot, under a control of the settlement center server, when the vehicle is determined by the settlement center server to be an illegal or a stolen vehicle.

5. The apparatus of claim 1, wherein the settlement center server receives the registration information stored in the ETC terminal from the DSRC base station and transmits the registration information to a system server connected with a different computer network, to thereby identify a credit of a user.

6. The apparatus of claim 1, wherein communication between the settlement center server and the DSRC base station is selectively made by a wired or a wireless media.

7. The apparatus of claim 1, wherein the vehicle sensor wirelessly communicates with the ETC terminal to recognize the vehicle is parked.

8. A parking charge settling apparatus, comprising:
a Vehicle Navigation System (VNS) terminal that stores registration information for parking charge settlement, including a user identifier and balance information, transmits the stored registration information to an external source in a dedicated short range communication (DSRC) format, receives available parking space information in the DSRC format, and displays the available parking space information on a liquid crystal display (LCD); and
a DSRC base station that receives the registration information from the VNS terminal and settles a computed parking charge by a bidirectional DSRC communication with the VNS terminal, when a vehicle mounting the VNS terminal enters a predetermined range.

9. The apparatus of claim 8, wherein the VNS terminal includes a smart card that records the registration information, including a user identifier and a balance, and automatically subtracts the parking charge computed by a settlement center server from the balance of the smart card.

10. A parking charge settling method, comprising:
transmitting response information from an Electronic Toll Collection ETC) terminal to a dedicated short range communication (DSRC) base station as the ETC terminal enters a predetermined range and receives an ETC broadcast information from the DSRC base station;
authenticating a vehicle on the basis of a user identifier transmitted from the ETC terminal and assigning an available parking space, if the vehicle is entering;
recognizing the user identifier transmitted from the ETC, computing a parking charge according to a parking time, and transmitting the computed parking charge to the ETC terminal, if the vehicle is leaving; and
receiving the parking charge, subtracting the parking charge from a balance of a smart card within the ETC terminal, and transmitting settlement completion information to the DSRC base station by the ETC terminal.

11. The method of claim 10, wherein assigning an available parking space farther comprises:
requesting available parking space information from a vehicle sensor managing server, which manages parking state information of a parking lot; and
receiving the available parking space information from the vehicle sensor managing server and displaying it on a guide displayer.

12. The method of claim 11, wherein the vehicle sensor managing server checks a vehicle sensor installed at a parking space to judge whether the parking space is available for parking and manages the parking state information according to the judgement.

13. The method of claim 10, further comprising:
transmitting the user identifier received from the ETC terminal, when the vehicle enters or leaves a parking lot, to a server of an authentication institution, to judge whether the vehicle is an illegal or a stolen vehicle; and
photographing the vehicle and its driver to make a data file if the vehicle is judged to be the illegal or stolen vehicle.

14. The method of claim 13, further comprising blocking the vehicle judged as the illegal or stolen vehicle from advancing by operating a lifting gate.

15. The method of claim 10, wherein transmitting response information to the DSRC base station further comprises:
requesting an available DRSC channel from the DSRC base station by the ETC terminal;
transmitting available DSRC channel information to the ETC terminal by the DSRC base station; and
transmitting, from the ETC terminal to the DSRC base station through the available DSRC channel, registration information for parking charge settlement.

16. A subscriber fee settling system, comprising:
a subscriber terminal containing subscriber information;
a base station that communicates with the subscriber terminal using a wireless medium;
a server that communicates with the base station to receive the subscriber information communicated by the subscriber terminal to the base station, computes a subscriber fee based on the subscriber information, and communicates the subscriber fee to the subscriber terminal via the base station; and
a service sensor that communicates with the server to identify whether a service is available for allocating to a subscriber.

17. The subscriber fee settling system of claim 16, further comprising:
a smart card integrated with the subscriber terminal that stores the subscriber information and communicates the subscriber information to the subscriber terminal, wherein
the subscriber information stored by the smart card includes a subscriber identification and an account balance, and
the subscriber information stored by the smart card may be revised by update information received from the server.

18. The subscriber fee settling system of claim 16, further comprising:
a display device that displays information communicated to the display device by the server, wherein
the display device displays the subscriber fee and whether the service is available to the subscriber.

19. The subscriber fee settling system of claim 16, further comprising:
a first display device and a second display device that each display information communicated by the server, wherein
the first display device displays the subscriber fee, and
the second display device displays whether the service is available to the subscriber.

20. The subscriber fee settling system of claim 16, further comprising:
a sensor server that manages the operation of a plurality of service sensors and communicates sensor management information to the server, wherein
each service sensor communicates with the sensor server to inform the sensor server whether the respective service sensor detects the provisioning of the service to a separate one of a plurality of subscribers.

21. The subscriber fee settling system of claim 16, further comprising:
a display device that displays information communicated to the display device by the server; and
a sensor server that manages the operation of a plurality of service sensors and communicates sensor management information to the server, wherein
each service sensor communicates with the sensor server to inform the sensor server whether the respective service sensor detects the provisioning of the service to a separate one of a plurality of subscribers, and
the display device displays the sensor management information so the subscriber can determine whether the service is available and an amount of the service that is available to the subscriber.

22. The subscriber fee settling system of claim 16, further comprising:
a camera that records images of the subscriber and a vehicle driven by the subscriber, under the control of the server, wherein
the camera records an image of the subscriber and the vehicle if the server identifies an abnormality regarding the subscriber information.

23. The subscriber fee settling system of claim 16, further comprising:
a lift gate that obstructs egress by the subscriber, under the control of the server, wherein
the lift gate obstructs the subscriber's egress if the server identifies an abnormality regarding the subscriber information.

24. The subscriber fee settling system of claim 16, further comprising:
a display device that is integrated with the subscriber terminal and displays information communicated to the display device by the server, wherein
the display device displays the subscriber fee and whether the service is available to the subscriber.

25. A subscriber fee settling method, comprising:
communicating a service request from a subscriber terminal to a base station terminal by wireless communication;
displaying the availability of a service for viewing by a subscriber having the subscriber terminal; and
communicating a service fee from a server to the subscriber terminal, by wireless communication, and debiting the service fee from an account balance maintained by the subscriber terminal.

26. The subscriber fee setting method of claim 25, further comprising:
sensing an amount of service available for provisioning to the subscriber and communicating the amount to the server.

27. The subscriber fee settling method of claim 25, further comprising:
sensing an amount of service available and locations of available service for provisioning to the subscriber and communicating the amount and the locations to the server through a display.

28. The subscriber fee settling method of claim 25, further comprising:
communicating subscriber registration information to the server with the service request; and
recording imagery information of the subscriber when an abnormality is identified by the server regarding the subscriber registration information.

29. The subscriber fee settling method of claim 25, further comprising:
communicating subscriber registration information to the server with the service request; and
obstructing the subscriber's egress from a location when an abnormality is identified by the server regarding the subscriber registration information.
